(19) United States
(12) Patent Application Publication
(10) Pub. No.: US 2004/0145741 A1
(43) Pub. Date: Jul. 29, 2004

(54) Comb etalon fluid analyzer

(75) Inventors: Barrett E. Cole, Bloomington, MN (US); Arunkumar Subramanian, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/350,984

(22) Filed: Jan. 24, 2003

(51) Int. Cl. G01N 21/00

(52) U.S. Cl. 356/436

(57) ABSTRACT

An analyzer for depicting a characteristic of a fluid with the alignment and nonalignment of transmission peaks of a light source and absorption lines of the fluid. A radiation source may emit light through broad band and narrow band filters, respectively. An output the narrow band filter having transmission peaks goes through a cell having the fluid to be examined. The fluid has absorption lines. The optical path of the narrow band filter varies so as to affect the alignment of the transmission peaks and the absorption lines which results in different magnitudes of the light from the cell which may imply a quantity or characteristic of the fluid. The analyzer may be made with MEMS techniques.

### BACKGROUND

This invention relates to the field of infrared fluid analysis and particularly to a device in which light is transmitted through a fluid sample at discrete frequencies correlated with the absorption spectrum of a constituent of the fluid to detect and quantitatively measure the constituent. “Fluid” is a generic term that includes liquids and gases as species. For instance, air, CO, water and oil are fluids.

In the apparatus conventionally used for infrared fluid analysis, a beam of infrared radiation having an emission spectrum embracing the absorption spectrum of the fluid to be analyzed goes through a fluid sample to a transducer. The output signal from the transducer is compared with that produced by passing the beam through the series combination of the sample and a reference fluid of the type selected for analysis. A signal intensity differential, produced by absorption in the sample, is converted to a detectable signal and displayed.

One problem with such analyzers is the difficulty of analyzing quantities of fluid constituents present in the low parts per million range. The signal intensity differential represents a relatively small change in a large signal and is frequently obscured by spectral interference between absorption spectra of the constituent being analyzed and absorption spectra of coexistent constituents. Another problem is the lack of inexpensive approaches for manufacturing numerous analyzers.

### SUMMARY OF THE INVENTION

The present invention transmits light through a fluid sample at discrete frequencies that may be correlated with the absorption spectra of a constituent of a fluid to detect and measure the constituent. It is a device that may be made with the techniques of micro electro mechanical system (MEMS) fabrication techniques for attaining inexpensive manufacturing advantages. The analyzer design is capable of accurately analyzing fluid in a small number of parts per million range.

### BRIEF DESCRIPTION OF THE DRAWINGS

FIG. 1 is a block diagram of a fluid analyzer;

FIG. 2 is a schematic of a fluid analyzer;

FIG. 3 illustrates an absorption spectrum of an illustrative fluid example;

FIG. 4 is a diagram of fluid analyzer of another configuration;

FIGS. 5, 6 and 7 are graphs showing various aspects of alignment of transmission peaks and absorption lines of an illustrative fluid;

FIG. 8 is a cross-section view of a narrow band filter;

FIG. 9 is a diagram showing some characteristic modifications that radiation encounters as it passes through components of an analyzer;

FIG. 10 shows a graph of thermal pulses versus wavelength for a filter layer;

FIG. 11 shows an implementation of a filter of an analyzer in an illustrative example of monolithic form;

FIG. 11a is a graph of thermal pulses in a filtering layer;

FIG. 12 reveals a layer having a current loop in place among magnetic components;

FIG. 13 shows the components of FIG. 12 proximate to a housing mount;

FIG. 14 is an exploded view of an example analyzer; and

FIG. 15 is an external view of a housed analyzer.

### DESCRIPTION

The light from the infrared frequency region is transmitted through a sample of fluid material at discrete frequencies correlated with the absorption spectrum of a molecular species thereof to detect and quantitatively measure the species. In FIG. 1, a fluid analyzer 10 may have a light source 12 for generating incoherent infrared radiation. A primary filter 16 may be adapted to receive the light and selectively transmit light having a frequency range in the region of an absorption band for the molecular species to be detected. A secondary filter 18, adapted to receive the filtered light, may transmit light at a plurality of discrete frequencies forming a plurality of fringes which provide a detectable signal. Secondary filter 18 may have interference producing mechanism for providing a plurality of transmission windows regularly spaced in frequency. The frequency spacing between adjacent windows may be adjusted to equal substantially the product of the frequency difference between adjacent spectral lines of the absorption spectrum for the molecular species to be detected and the factor (n/n′), where n and n′ are integers and n does not equal n′. Under these circumstances, the interference producing device may form a comb filter. Secondary filter 18 also may have a scanning device for causing the transmission peaks for adjacent n′th orders to coincide substantially with the spectral lines of such absorption spectrum. A cell 20 may be provided for transmitting the detectable signal through the fluid material, thereby the intensity of the detectable signal changes in proportion to the concentration of the molecular species. The intensity change of the detectable signal may be converted to a measurable form by a signal conditioner 22, and the magnitude thereof may be indicated by detector 24.

Further, an approach for detecting and quantitatively measuring a molecular species of fluid material in a sample to be analyzed, may include generating light in the form of incoherent infrared radiation; collecting, collimating and transmitting the light; filtering the light so as to selectively transmit light having a frequency range in the region of an absorption band for the molecular species to be detected; interferometrically filtering the filtered light and transmitting light at a plurality of discrete frequencies to form a plurality of fringes which provide a detectable signal by directing the light through a plurality of transmission windows regularly spaced in frequency, the frequency spacing between adjacent windows being equal substantially to the product of the frequency difference between adjacent spectral lines of the absorption spectrum for the molecular species to be detected and the factor n/n′, where n and n′ are integers and n does not equal n′, and scanning the light to cause the transmission peaks for adjacent n′th orders to coincide substantially with the spectral lines of the absorption spectrum, the detectable signal having an intensity substantially equal to the sum of the fringes; transmitting the detectable signal through the fluid material, whereby the intensity of the detectable signal changes in proportion to the concentration of the molecular species; and detecting and indicating the intensity change of the signal.

Several filters may be used with the above apparatus. Secondary filter 18 may be a Fabry-Perot interferometer (FPI) having a mirror separation, d, adjusted to transmit the filtered light at a plurality of discrete frequencies correlated with the absorption spectrum of a molecular species of the fluid material. This condition may be obtained when

d=(n′/4μBn)

where d is the mirror separation of the Fabry-Perot interference filter, μ is the index of refraction of the medium between the mirrors. B is the molecular rotational constant of the species n and n′ are integers and n does not equal n′. For a given molecular species, the rotational constant B is a unique quantity. Thus, identification of the species having a particular absorption spectrum may be made by adjusting the mirror separation of the interference filter such that the discrete frequencies transmitted coincide substantially with the absorption lines of the molecular species to be detected. Advantageously, the intensity of the detectable signal should not be affected by molecular species other than the species appointed for detection and the intensity differential represents a relatively large change in a small signal. Spectral interference may be minimized and no reference fluid is needed. The sensitivity of the apparatus is increased and highly sensitive forms and combinations of detectors, sources, filters and control systems generally are unnecessary. As a result, this device may permit fluid constituents to be detected more accurately and at less expense than systems wherein the emission spectrum of light passed through the sample contains a continuum of frequencies.

Again in FIG. 1, fluid analyzer may be for detecting and quantitatively measuring a molecular species of fluid material. Analyzer 10 may have light source 12 for generating light 15 containing incoherent infrared radiation. A light conditioner 14 may collect, collimate and transmit light 15 to a primary filter 16. Primary filter 16 may be adapted to receive light 15 and selectively transmit light 17 having a frequency range in the region of an absorption band for the molecular species to be detected. Secondary filter 18, adapted to receive the filtered light 17, may transmit light at a plurality of discrete frequencies forming a plurality of fringes which provide a detectable signal 30. Detectable signal 30 may be transmitted through fluid material in cell 20. A signal conditioner 22 may convert to measurable form, intensity changes created in signal 30 by the molecular species of the fluid material in cell 20. The magnitude of the intensity change may be indicated by detector 24.

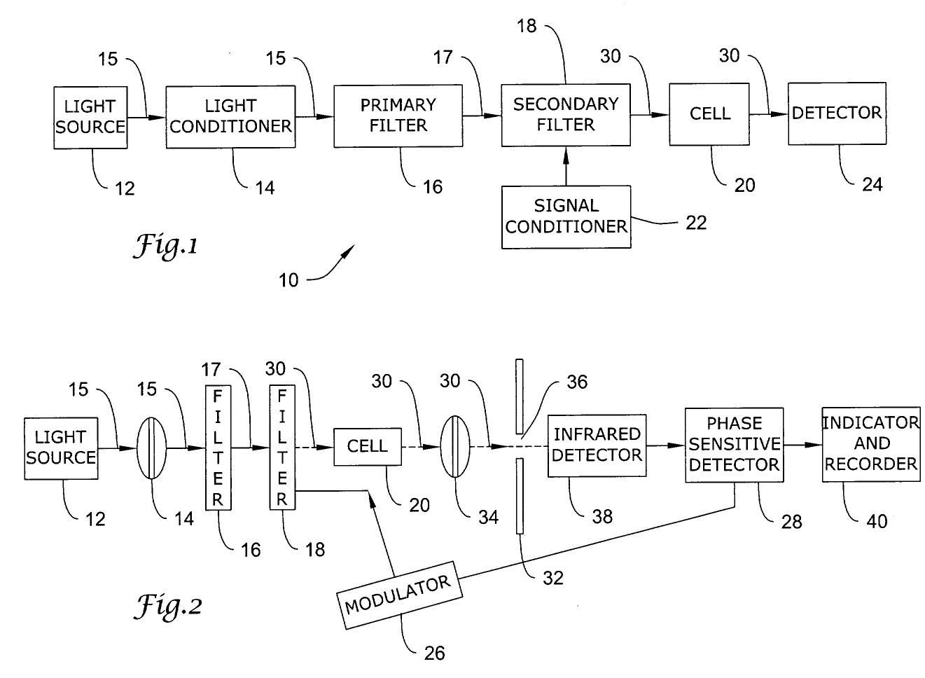

More specifically, as shown in FIG. 2, primary filter 16 may be a narrow band pass filter composed of multiple layers of dielectric thin films, and secondary filter 18 may have interference producing device for providing a plurality of transmission windows regularly spaced in frequency. In addition, secondary filter 18 may have scanning device for variably controlling the frequency of each order. The interference producing device may be adjusted so that the frequency spacing between adjacent windows equals substantially the product of the frequency difference between adjacent spectral lines of the absorption spectrum for the molecular species to be detected and the factor (n/n′, where n and n′ are integers and n does not equal n′. Under these circumstances, detectable signal 30 transmitted by secondary filter 18 may have an intensity substantially equal to the sum of the fringes. Moreover, the intensity of signal 30 should not be affected by molecular species other than the species appointed for detection, referred to hereinafter as the preselected species.

Upon transmission of detectable signal 30 through fluid material in cell 20, its intensity may change in proportion to the concentration of the preselected species. Such intensity change may be converted to measurable form by signal conditioner 22. The latter may have a modulator 26 for modulating the phase difference between interfering rays of light transmitted by secondary filter 18 so as to shift the frequency of each fringe transmitted thereby. Signal conditioner 22 also may have synchronous (e.g., phase sensitive) detector 28 for detecting the intensity variation of signal 30, whereby the magnitude of the intensity change can be identified by detector 24.

Several kinds of filters may be used as the secondary filter 18. For an illustrative example, secondary filter may be a Fabry-Perot interferometer having a mirror separation, d, adjusted to transmit filtered light from primary filter 16 at a plurality of discrete frequencies correlated with the absorption spectrum of the preselected species. The transmission function of an FPI (Iₜ) can be given by the Airy formula: Iₜ=T²[1+R²−2cos ø]⁻¹(Iₒ) where T+R+A=1, Iₒ is the intensity of the incident light, and the phase difference ø is expressed as ø=4πμωd for rays normal to the FPI mirrors. The symbols A, R and T represent, respectively, the absorbance, reflectance and transmittance of the FPI mirrors, μ is the refractive index of the medium between the FPI mirrors, d is the FPI mirror separation, and ω is the frequency of the incident light expressed in wavenumbers. When cos ø is equal to unity, transmission maxima for Iₜ may occur. Hence, ø=2 μm, where m takes on integral values and represents the order of interference. The transmission maxima for Iₜ may be referred to in the specification and claims as transmission windows. For a specific value of the mirror separation, d, the FPI provides a plurality of transmission windows regularly spaced in frequency. The frequency spacing, Δf, between adjacent windows (or spectral range) of the FPI is Δf=(2μd)⁻¹. For a simple diatomic molecule such as carbon monoxide, the frequency spacing between adjacent absorption lines of the infrared rotation-vibration absorption spectrum is approximately equal to 2B. By varying the mirror spacing, d, of the FPI, Δf can be adjusted to substantially equal the frequency difference between adjacent spectral lines of part or all of the absorption spectrum for the preselected species. That is, continuous scanning of the FPI in the vicinity of

d=1/4μB

may produce an absorption interferogram having a plurality of fringes corresponding to a superposition of substantially all the absorption lines of the preselected species. When Δf=2B, the transmission peaks for adjacent orders may coincide substantially with the adjacent spectral lines of the absorption spectrum so as to produce a one-to-one correspondence therewith, and the amplitude of the signal from fluid sample 20 is a minimum. For values of Δf slightly different from 2B, the transmission peaks for adjacent orders would not perfectly coincide with the absorption lines and the amplitude of the signal from fluid cell 20 will decrease.

Other absorption interferograms may be produced for values of the interferometer mirror separation.

d≈n′/(4μBn)

where n and n′ are integers and n does not equal n′. These absorption interferograms are produced when Δf is equal to certain multiples of the rotational constant, B. The principal interferograms may be produced when every absorption line coincides with a different transmission window of the FPI. Such principal interferograms may be obtained for values of interferometer mirror separation

d≈n′/4μBn

where n is equal to 1 and n′ is an integer greater than 1. More specifically, for values of interferometer mirror separation d=n′/(4μB) where n′ is an integer greater than 1, the principal interferograms may be obtained. For example, with n′=3, radiation may be transmitted by the interferometer not only at frequencies corresponding with those of adjacent absorption lines of the molecular species to be detected but also at two discrete frequencies located between each pair of the absorption lines. Secondary interferograms may be obtained when every other absorption line or every third absorption line (and so on) coincides with the transmission peaks of the FPI. Such secondary interferograms may be obtained for values of the interferometer mirror separation

d≈n′/4μBn

where n is an integer greater than 1 and n′ is equal to 1. More specifically, for values of interferometer mirror separation d=(1/4μBn) where n is an integer greater than 1, the secondary interferograms may be obtained. For example, with n=3, radiation may be transmitted by the interferometer at frequencies corresponding with those of every third absorption line of the molecular species to be detected.

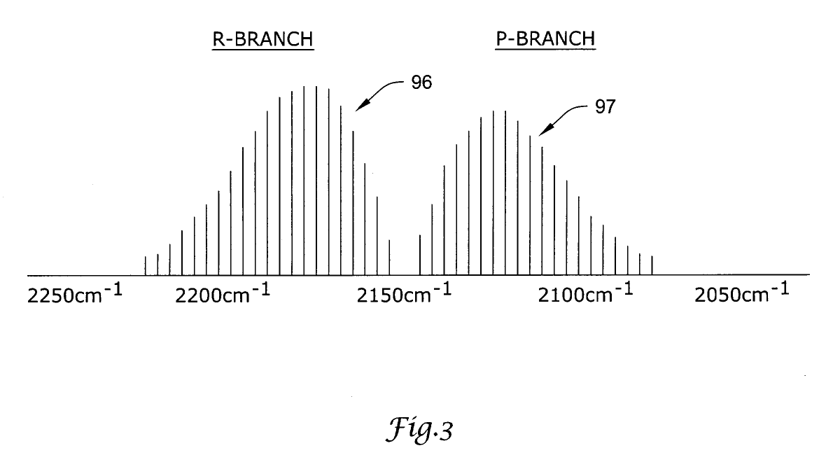

Use of infrared fluid analyzer 10 may be exemplified in connected with the detection of a diatomic molecule such as carbon monoxide. Carbon monoxide (CO) has a vibration-rotation absorption band in the wavelength region of about 4.5-4.9μ, with its band center at about 4.66μ. This absorption band corresponds to transitions from the ground vibrational state (v=0) to the first vibrational state (v=1). As shown in FIG. 3, the absorption band may consist of two branches: an “R-branch” 96 corresponding to rotation-vibration transitions for which the rotational quantum number J changes by +1 and a “P-branch” 97 corresponding to rotation-vibration transitions for which the rotational quantum number J changes by −1. The frequencies, in units of wavenumbers, of the rotational transitions for the R an P branches are given by the formulas

ω_{R}=ω_{O}+2B₁+(3B₁−B_{O})J+(B₁−B_{O})J²

with J=0, 1, 2, . . .

ω_{P}=ω₀−(B₁+B₀)J+(B₁−B₀)J²

with J=1, 2, 3, . . .

The quantities ω_{O}, B₀ and B₁ represent the absorption band center frequency, the ground state rotational constant and the first vibrational state rotational constant, respectively. The rotational constants B₀ and B₁ may be related according to the equation

B₀=B₁+αₑ

where αₑ is the rotation-vibration interaction constant. Values for the rotational constants of carbon monoxide appear to be:

B₀=1.9225145 cm⁻¹

B₁=1.9050015 cm⁻¹

αₑ=0.017513 cm¹

The intensity distribution for the R and P branches may be given by the equation

I_{abs}=(2C_{abs}ω/Q_{R})S_{J} exp [−B₀J(J+1) (hc/kT)]

where C_{abs} is a constant factor, Q_{R} is the rotational partition function (≈kT/hcB), ω is the frequency, in wavenumbers, of the individual rotation-vibration absorption lines, h is Planck's constant, c is the speed of light, k is the Boltzmann constant, T is the absolute temperature and the line strengths S_{J} are:

S_{J}=J+1 for the R-branch

S_{J}=J for the P-branch

Using these equations for line positions and intensities, a schematic representation of the CO absorption spectrum shown in FIG. 3, may be constructed. The representation may be termed schematic as, in reality, each rotational absorption line of the spectrum has a small but finite width.

In order to utilize a Fabry-Perot interferometer to provide discrete frequencies of light at the frequencies of the absorption lines of the band, it may be necessary to determine the effect of the non-periodic spacing of the rotational absorption lines on the operation of analyzer 10. For this purpose the Fabry-Perot interferometer may be adjusted such that the J=6 and J=7 R-branch rotational absorption lines coincide exactly with two adjacent discrete frequencies from the Fabry-Perot interferometer. These two rotational absorption lines appear to be the strongest lines in the band. Their frequencies are:

ω_{R}(J=6)=2169.169975 cm⁻¹

ω_{R}(J=7)=2172.734796 cm⁻¹

The wavenumber difference between these lines may be 3.564821 cm⁻¹. The free spectral range of the interferometer may be adjusted to be equal to this wavenumber difference between adjacent lines. In order to determine the manner in which the mismatch of the light frequencies from the interferometer and the individual rotational absorption lines occur, the quantity Ω_{R}=ω_{R}(J+1)−ω_{R}(J) may be calculated. The quantity Ω_{R} may be evaluated as follows:

Ω_{R}=ω_{R}(J+1)−ω_{R}(J)=(3B₁−B₀)−αₑ[(J+1)²−J²]=(3B₁−B₀)−αₑ(2J+1).

Therefore, the frequency difference between adjacent rotational absorption lines in the R-branch may change in direct proportion with the rotational quantum number J and the rotation-vibration interaction constant αₑ. The halfwidth, A, of the Fabry-Perot transmission windows may be given by the equation

A=(1−R)/(2μdπR^{1/2})

where R is the reflectivity of the Fabry-Perot mirrors and μd is the optical path length between the mirrors. Assuming that the reflectivity R=0.85, then A=0.185 cm¹. The frequency mismatch with the ω_{R}(J=5) line is about 0.035 cm⁻¹, which is well within the transmission halfwidth of the Fabry-Perot interferometer. The frequency mismatch with the ω_{R}(J=3) line may be 0.210 cm⁻¹, which is just slightly larger than the FPI halfwidth. The frequency mismatch with the ω_{R}(J=¹⁰) line may be 0.210 cm⁻¹, which is also just slightly larger than the FPI halfwidth. Therefore, the R-branch lines from J=3 to J=10 may coincide substantially with the discrete frequencies from the FPI and therefore be most effective in the operation of analyzer 10. The absorption line positions can be determined relative to the FPI transmission windows. From the equation for Ω_{R}, the non-periodicity of the absorption line positions may be given by the term αₑ(2J+1). Equating this to the FPI transmission halfwidth yields

A=αₑ(2J_{R}+1)

[(1−R)/(2μdπR^{1/2})]=αₑ(2J+1)

Since (1/2μd)=free spectral range, it may be set to be equal to the product of the periodic contribution in the equation for Ω_{R}, namely, 3B₁−B₀, and the factor n/n′ (n/n′) (3B₁−B₀) [(1−R)/(πR^{1/2})]=αₑ(2J_{R}−1)

Solving for J_{R}

J_{R}={[n(3B₁−B₀)/(2αₑn′)]/[(1−R)/πR^{1/2})]}−1/2

The equilibrium value of the rotational constant Bₑ may be given as

Bₑ=Bᵥ+αₑ(v+1/2)

where Bᵥ is the rotational constant of the v-th vibrational state.

Hence, 3B₁−B₀=2Bₑ−4αₑ, and

J_{R}=n/n′{[(Be/αe)−2][(1−R)/(πR^{1/2})]}−1/2

For CO, Bₑ=1.931271 cm⁻¹ and assuming a FPI mirror reflectivity of 0.85,

J_{R}=5.6 n/n′−0.5.

Similarly, for the P-branch

Ω_{P}=ω_{P}(J+1)−ω_{P}(J)=−(B₁+B₀)−αₑ(2J+1)

and the same reasoning yields

J_{P}=(n/n′){[(Bₑ/αₑ)−1][(1−R)/(πR^{1/2})]}−1/2

Since Bₑ/αₑ>>1, J_{R}=J_{P}. The values of J_{R} and J_{P} can be denoted by Jₒₚₜ. Therefore, the optimum bandwidth of primary filter 16 should be equal to approximately 2BₑJₒₚₜ and no greater than 4BₑJₒₚₜ. The value of Jₒₚₜ for the principal interferograms having n′=3, for example, may be equal to 1.4. Thus, it may be always possible to match the transmission windows of the interferometer with at least two absorption lines of the species appointed for detection.

For the principal interferogram of CO with n′=3, the interferometer may transmit radiation through transmission windows corresponding to the frequencies of at least two of the absorption lines appointed for analysis and, in addition, through two extra tramission windows spaced at equal frequency intervals with and between the absorption lines appointed for analysis. In situations where the absorption lines of the fluid being analyzed are relatively narrow and exist in a frequency region that does not contain interfering absorption lines from other fluids, one may use of principal inteferograms of the type wherein n′=3 provides increased sensitivity. The increase in sensitivity may be produced by the better match created between absorption linewidth and the widths of the interferometer's transmission windows. The decrease in sensitivity otherwise resulting from the presence of additional FPI transmission windows may be offset by the increase in sensitivity achieved by reducing the width of the FPI transmission windows. The increase in sensitivity which is realized in a particular situation may depend on the value of n′ selected, which, in turn, is governed by the experimental conditions associated with the fluid sample under investigation. It may be significantly greater than that produced by increasing the reflectivity of the FPI mirrors. The latter approach may permit narrowing the width of the FPI transmission windows without introducing additional radiation not absorbed by the fluid, and would, at first, appear to be a better way to improve the match between absorption linewidth and FPI transmission linewidth. In practice, however, for high mirror reflectivities the transmissivity of the FPI may be decreased by small absorption and/or scattering losses in the FPI mirrored surfaces. This reduction in transmissivity may result in a decrease in sensitivity that is greater than the sensitivity loss produced by introduction of additional transmission windows discussed above. Further, the use of lower reflectivity FPI mirrors with high transmissivity may result in a device that can be used for a larger number of experimental applications.

For the secondary interferograms of CO with n=3, a value of 16 may be obtained for the quantity Jₒₚₜ. This value for Jₒₚₜ indicates that absorption of radiation transmitted by the FPI may occur over a frequency range that contains approximately 16 absorption lines. In use of a secondary interferogram having n=3, FPI transmission windows may occur at every third absorption line, so that absorption will take place at only five absorption lines. The usefulness of these secondary interferograms is anticipated for the cases where fluid mixtures are being analyzed. In such cases strong absorption lines from a fluid other than the one appointed for analysis may interfere with the measurement of the fluid selected for analysis. This interference may be reduced or eliminated by selecting a secondary interferogram which does not provide radiation at the absorption frequencies of the interfering fluid.

As previously noted, modulator 26 may modulate the phase difference, ø, so as to vary the intensity of transmitted signal 30. In order to obtain the maximum modulated signal, the modulating range may be adjusted to approximately 1/2 the frequency spacing between adjacent fringes. The modulating range can, alternatively, be restricted to preselected portions of the absorption spectrum of the preselected species in order to increase the intensity of the modulated signal. Generally speaking, the modulating range should be no greater than the frequency spacing between adjacent absorption lines of the preselected species.

Resultant signal 30 from secondary filter 18 and fluid cell 20 may be focused in the plane of pinhole stop 32 by lens 34. Lens 34 may be adjusted so that the center of the signal is positioned on pinhole 36. The intensity of the portion of signal 30 passing through pinhole 36 may be detected by an infrared detector 38. Phase sensitive detector 28, such as a lock-in amplifier, may be adapted to receive the signal from infrared detector 38 and detect the intensity variation thereof. The output of phase sensitive detector 28, representing the signal intensity change, may be displayed by an indicator and recorder 40, which may have an oscilloscope and a chart recorder.

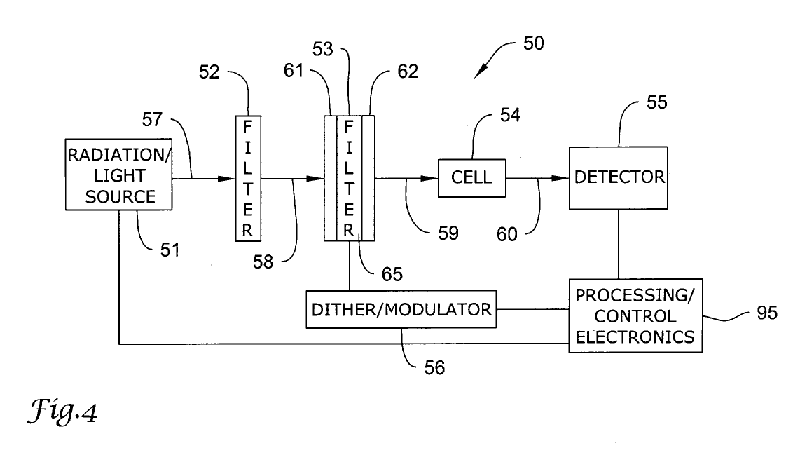

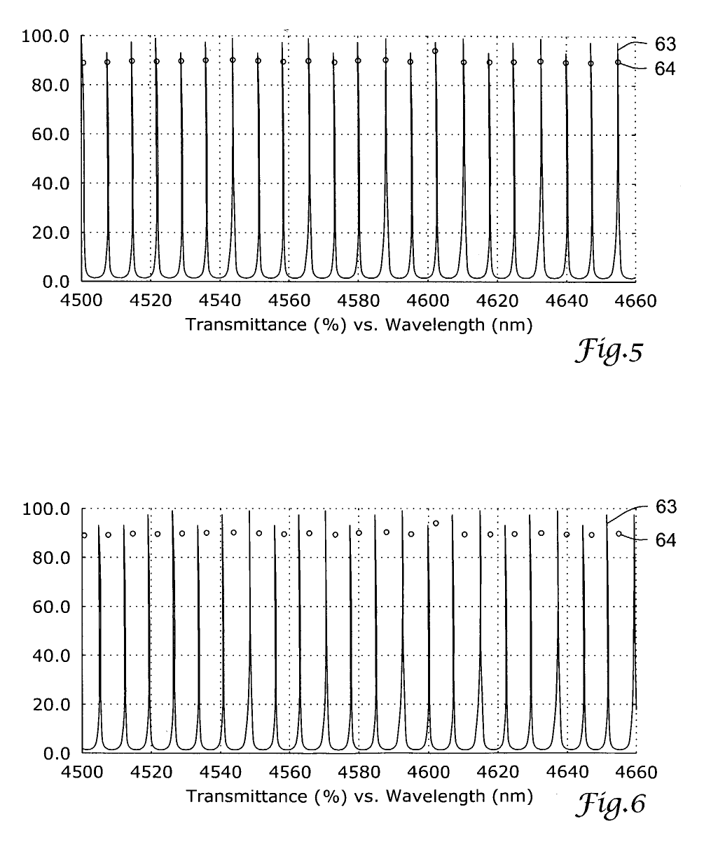

FIG. 4 shows configuration 50 having a radiation source 51 that may emit radiation or light 57 through a broadband filter 52. From filter 52 light 58 may go through a narrowband filter 53. Filter 52 may be designed to limit light 57 to light 58 of interest. Filter 53 may have somewhat reflective surfaces 61 and 62 to form an interference space or cavity between the surfaces. Filter 53 may be a layer 65 of silicon with reflective surfaces 61 and 62 on both sides of layer 65. As light 59 comes through filter 53, it may develop transmission peaks 63 resulting in a comb structure typical of a Fabry-Perot filter as shown in FIGS. 5, 6 and 7. Light 59 may go through cell 54 which contains some fluid. For this illustrative example, carbon-monoxide (CO) is in cell 54. This fluid may have absorption spectral lines 64. These absorption lines may be based on rotational differences of the CO atom. These lines may constitute an absorption cross-section of the fluid, i.e., it is a characteristic of the fluid. The spacing of these lines may be rather equal or linear. These CO rotational absorption lines 64 are represented as circles in FIGS. 5, 6 and 7. The graphs of these figures show transmittance from zero to 100 percent versus wavelength from 4500 to 4660 nanometers. Transmission peaks 63 of light 59 may or may not be aligned with rotational absorption lines 64. When there is an alignment, the amplitude of light signal 59 may be reduced and the light may exit as light 60 from cell 54 to detector 55. With this alignment, there is absorption. When there is not alignment, light 59 may be pretty much all transmitted through cell 54 and exiting as light 60. The index of refraction or optical path length of filter 53 may be modulated, dithered or changed by tilting layer 65 about 7 degrees other appropriate amount in an alternating manner or other fashion, or by heating and cooling layer 65 about 20 degrees or other appropriate amount in an alternating manner or other fashion. A dither/modulator 56 may be connected to filter 53 to provide such modulation, dithering or changing of the layer's angle or temperature. Device 56 may be also referred to as an optical path varying mechanism. A processing and/or control electronics component 95 may connected to dither/modulator 56, detector 55 and/or radiation or light source 51, for reasons as may be desired. Component 95 may be a computer.

The measure of inherent light strength or intensity ratio may be a light 60 intensity when there is alignment and absorption, divided by a light 60 intensity when there is not alignment and no absorption.

$$\frac{{I}_{A}}{{I}_{NA}} = {I}_{R}$$

Detector 55 may do a summation of the intensity (flux) peaks.

Narrow transmission peaks 63 of light 59 may be moved relative to absorption lines 64 by changing the filtering characteristic of filter 53. This characteristic may be affected by changing the optical thickness of the filter. Several ways to do this changing include heating the filter 53 material to change the optical thickness and rotating filter 53 material at an angle relative to the incident direction of light 58. By changing optical thickness of filter 53, one is slithering or modulating transmission peaks 63 in and out of absorption structure lines 64. Filter 53 under this treatment may be regarded as an etalon.

$${I}_{R} = \frac{{I}_{A}}{{I}_{NA}} = {E}^{- kx} ; k = \frac{ln ( {I}_{A} / {I}_{NA} )}{x} ,$$

where k is the absorption constant and x is the absorption path length, i.e., the path of light or radiation through the fluid in cell 54. “k” indicates an amount of absorption at a particular band. “k” is proportional to the CO partial pressure which may be calculated as parts per million of CO in, for instance, a room. The thickness of a layer for filter 53 for a given fluid may be determined with an equation,

λ=m/nd,

where m is an integer, n is the index of refraction and d is the thickness of the layer. One may assume m=1 and Δλ=λ₁−λ₂. Δλ is the distance between the transmission peaks 63. A is the wavelength of the transmission and the absorption for alignment. One may note that

Δλ=1/nd.

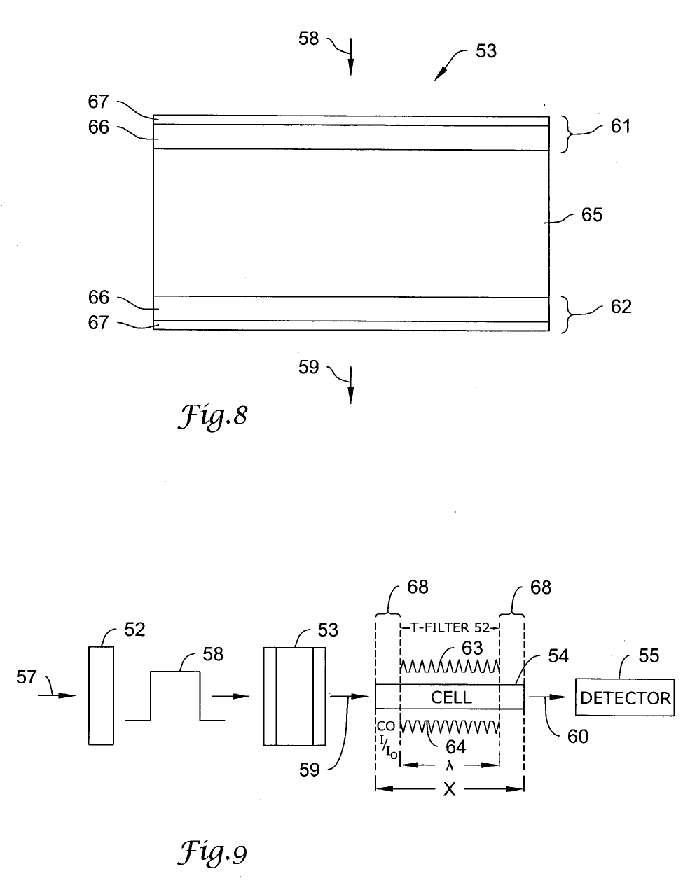

Filter 53 may be a membrane formed from a full layer thickness. The thickness of the membrane should be about 417 micrometers to provide a comb transmission structure in the case of CO. The specific thicknesses of the structure of filter 53 are calculated for the graphs of FIGS. 5, 6 and 7, may be 416.92 micrometers for a silicon layer 65, 810 nanometers for an SiO₂ layer 66 formed on the opposing surfaces of layer 65, and 338 nanometers for an Si layer 67 formed on each layer 66. Each set of layers 66 and 67 may form a mirror 61 and a mirror 62. The structure of filter 53 may resemble the one in FIG. 8 which is not drawn to scale.

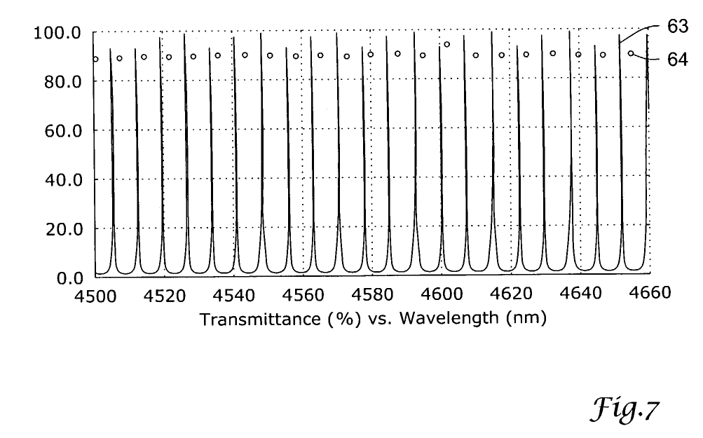

FIG. 5 shows the transmission comb structure with peaks 63 of light 59 from filter 53 aligned with rotational absorption lines 64 (in circles) with filter 53 at an ambient temperature. Transmission peaks 63 may be shifted so that they are not aligned with absorption lines 64 as shown in FIG. 6 by heating structure or filter 53 to a temperature that is 20 degrees centigrade greater than the ambient temperature of filter 53 as represented in FIG. 5. In another way, transmission peaks 63 may be shifted so that they are not aligned with absorption lines 64 as shown in FIG. 7 by rotating structure or filter 53 about seven degrees in either direction relative to its original position as represented in FIG. 5. The original position of structure or filter 53 may be such that the surface of its mirror 61 is approximately perpendicular relative to the direction of incident light 58.

In FIG. 9, radiation or light 57 may enter a T-filter 52. Light 57 may be well collimated. It may be an infrared light having a wavelength in the four micrometer range. Light source 51 may be a filament. Filter 52 may limit the range of wavelengths for light 58 which enters filter 53. The peaks 63 and lines 64 may or may not be aligned. Filter 52 may cut off portions 68 of peaks 63 that could have been present in cell 54 if filter 52 were not in place. “x” is the travel length or absorption path length of light 59 in the fluid of cell 54.

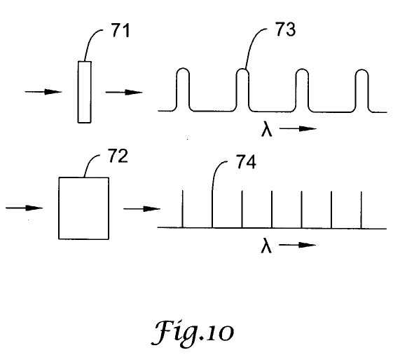

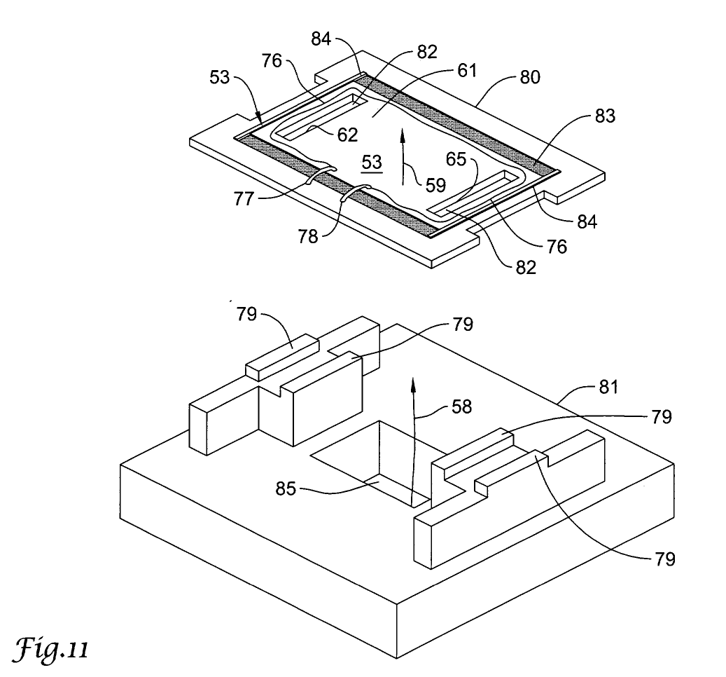

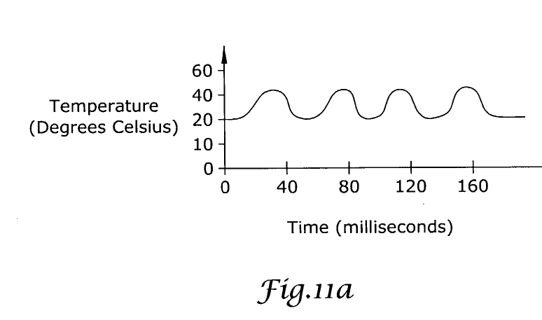

A thermally tuned filter 53 that would be treated as an etalon may need a certain amount of temperature change as determined by the optical thickness of the filter 53 layer. FIG. 10 shows thin layer 71 to have thicker transmission peaks 73 that are farther apart from each other wavelength wise than peaks 74 from thick layer 72. Obviously, thin layer 71 appears easier to warm up than thick layer 72. However, with thin layer 71 having a limited amount of material, there is relatively less phase change via the index of refraction change for a given temperature change. Peaks 73 may be effected with a 120 degree centigrade change, and peaks 74 may be effected with a 20 degree centigrade change. Thus, a greater temperature change appears to be needed for thin layer 71 than for thick layer 72 to effect a reasonable index of refraction change. This means that such etalon may need thermal tuning, since temperature change would somewhat be determined by the thickness of a layer in a filter, such as filter 53. FIG. 10 is not necessarily drawn to scale.

The present invention may be implemented in a monolithic wafer-like structure or in MEMS. FIG. 11 shows an implementation of the comb etalon filter 53 in a MEMS monolithic form. The structure may be made from silicon or any other appropriate material. Filter 53 may change its index of refraction by changing its position relative to the direction of incident radiation 58, or by changing its optical thickness. Filter 53 in FIG. 11 has a similar layer structure as layer 65 with mirrors 61 and 62 on the larger surfaces as opposite sides of layer 65. A conductor 76 is on the perimeter of filter 53. When electrical current is passed through conductor 76, it may heat up layer 65 and cause a change of index of refraction sufficient enough to cause alignment and non-alignment of transmission peaks 63 with absorption lines 64. The temperature change may be about 20 degrees Centigrade. The current may be turned on and off so as to pulse the filter thermally. FIG. 11a illustrates an example of thermal pulses in a layer versus time. The thermal time constant may be about ten milliseconds for a given silicon structure. The amount of degree change needed for appropriate dithering and the thermal time constant may be dependent on the filter 53 structure and material. The electrical current may be fed to an element or conductor 76 via bond wires 77 and 78. Conductor 76 may be wire-, plate-, layer- or wafer-like. It may have other forms. Magnets 79 would be absent in the structure of FIGS. 11, 12, 13, 14 and 15 for the filter 53 heating configuration.

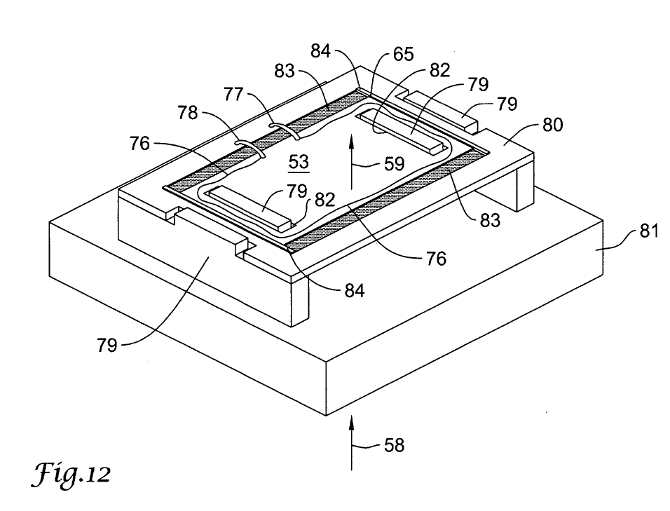

In another configuration, with conductor 76 having a sufficient current in it, the index of refraction or optical path length of layer 65 of filter 53 may be changed by tilting layer 65 about seven degrees relative to its perpendicular position to incident light 58. Rather than heating, the conductor may create a magnetic field that interacts with magnets 79 when yoke 80 and filter 53 are positioned on plate 81 as shown in FIG. 12. Magnetic forces between loop 76 and magnets 79 may be used to rotate or tilt layer 65 relative to the direction of light 58. If such rotation or dithering is done at a certain rate, the rate may be such that it is in sync with the mechanical resonance of layer 65 and associated structures and components thus requiring smaller current. An example rate of dithering might be about one kilohertz. Plate 81 may have a slot 85 for the passage of radiation or light 58. Magnets 79 may fit through slots 82 of filter 53. In such structure the current may be about 0.5 ampere in a magnetic field of approximately one tesla. These values may vary according to structure and material. Lower field currents are required for resonance operation. Layer 65 may supported in yoke 80 by flexible serpentine springs or other kind of structure 83 so that layer 65 can tilt or move relative to yoke 80. These springs 83 may be used to conduct current to loop 76 in lieu of bonding wires 77 and 78. Small gaps 84 may exist between layer 65 and yoke 80 so as to let layer 65 be moveable relative to yoke 80. Magnets 79 may be micromachined and be made from one or more of a variety of materials.

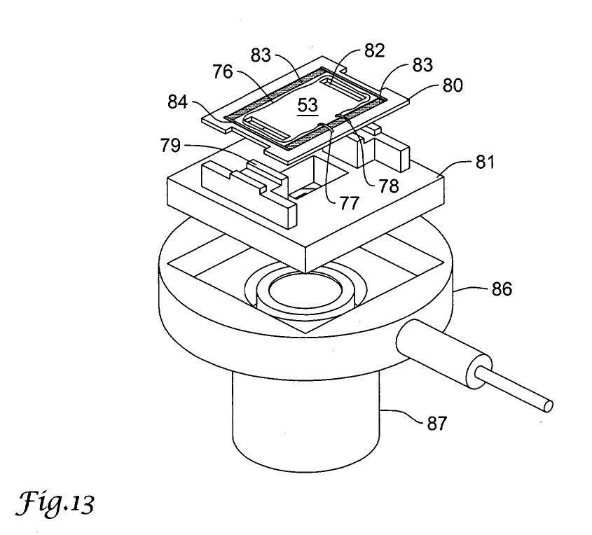

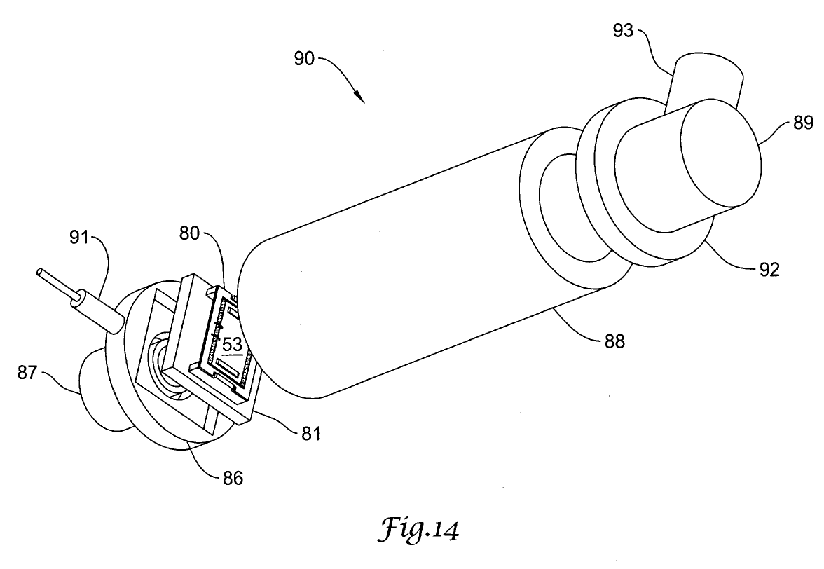

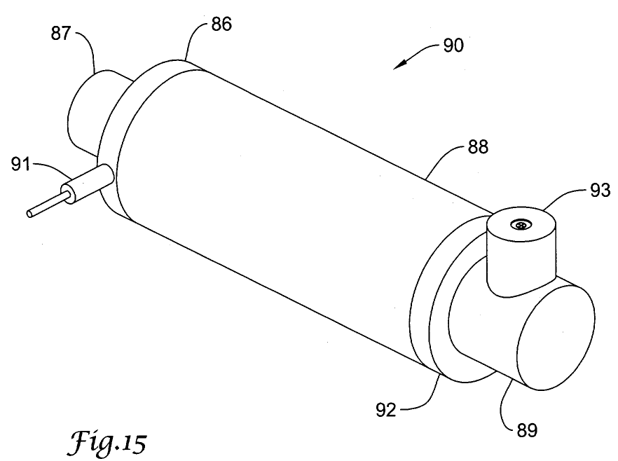

FIG. 13 shows where filter 53, yoke 80 and support structure 81 fit in with structures 86 and 87 that hold filter 52 and radiation or light source 51, respectively. FIG. 14 is an exploded view of structure 90 that may house configuration 50 or other configurations of the fluid analyzer. In addition to the structure components shown in FIG. 13, structure 90 may have a component 88 that holds fluid cell 54 and a component 89 that holds detector 55. A component 92 may support component 89 and may be a cap for structure 88. Power and modulation or dither signals may be from dither/modulator electronics 56 housed in structure 86 and/or 87; or dither/modulation signals may be fed into port 91. Port 93 may provide for communications to detector 55. Fluid cell 54 may be a container inserted into component 88, or component 88 may act as a fluid cell 54 with port 91 and/or 93 providing a way to put fluid in or to expel fluid from cell 54. On the other hand, ambient air or fluid may be free to flow through the fluid cell. FIG. 15 shows structure 90 assembled together with its components. Structure 90 and its components may be made or fabricated with MEMS and/or other technologies from one or more of a variety of materials.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. An analyzer comprising:
a layer;
a detector proximate to said layer; and
a source, proximate to said layer, wherein said source may emit radiation through said layer to said detector.

2. The analyzer of claim 1, wherein said layer has a first surface and a second surface, and the first and second surfaces have at least some reflective characteristics, the surfaces being approximately perpendicular to radiation that may go through said layer.

3. The analyzer of claim 2, wherein said layer is dithered so as to affect an optical path length through said layer, the optical path length being approximately perpendicular to the first and second surfaces.

4. The analyzer of claim 3, further comprising:
a conductor situated on said layer, and
a source of a magnetic field proximate to said conductor.

5. The analyzer of claim 4, wherein applying a signal to said conductor affects the optical path length through said layer.

6. The analyzer of claim 5, wherein said layer is tilted upon the applying a signal to said conductor, thereby affecting the optical path length through said layer.

7. The analyzer of claim 6, further comprising a cell situated between said source and detector.

8. The analyzer of claim 7, wherein said layer has a thickness so as to result in an output of radiation peaks having a delta wavelength between then that match up with some absorption peaks of a fluid in said cell.

9. The analyzer of claim 8, wherein the first and second surfaces of said layer form an interference filter.

10. The analyzer of claim 9, wherein affecting the optical path length results in at least an occasional alignment and/or misalignment of the radiation peaks with some of the absorption peaks thereby reducing an intensity of the radiation at the detector.

11. The analyzer of claim 10, wherein said layer is made with micro-electro-mechanical systems (MEMS) fabrication.

12. The analyzer of claim 3, further comprising a heating mechanism proximate to said layer.

13. The analyzer of claim 12, wherein activating said heating mechanism heats up the layer thereby affecting the optical path length through said layer.

14. The device of claim 13, further comprising a cell situated between said source and detector.

15. The analyzer of claim 14, wherein said layer has a thickness so as to result in an output of radiation peaks having a delta wavelength between then that match up with some absorption peaks of a fluid in said cell.

16. The analyzer of claim 15, wherein affecting the optical path length results in at least an occasional alignment and/or misalignment of the radiation peaks with some of the absorption peaks thereby reducing an intensity of the radiation at said detector.

17. The analyzer of claim 16, wherein the first and second surfaces of said layer form an interference filter.

18. The analyzer of claim 17, wherein the interference filter is a Fabry-Perot filter.

19. The analyzer of claim 18, wherein said layer is made with micro-electro-mechanical systems (MEMS) fabrication.

20. An analyzer comprising:
a radiation source;
a filter proximate to said radiation source;
a cell proximate to said filter;
a detector proximate to said cell; and
an optical path modifying mechanism connected to said filter; and
wherein:
radiation, emitted from said radiation source through said filter, emerges from said filter with transmission peaks;
said cell has some fluid, which has an absorption spectrum of lines that have about the same wavelengths as the transmission peaks of the radiation;
said optical path varying mechanism may change the optical path of said filter to shift the transmission peaks in and out of alignment of the absorption lines; and
said detector may detect possible amplitude variations of the radiation from said cell.

21. The analyzer of claim 20, wherein said optical path varying mechanism may change the optical path of said filter by tilting said filter relative to an incident direction of the radiation going through said filter.

22. The analyzer of claim 21, wherein said optical path varying mechanism may tilt said filter with a magnetic force.

23. The analyzer of claim 22, wherein a ratio of high and low amplitudes of the radiation detected by said detector is calculated.

24. The analyzer of claim 23, wherein said filter is a monolithic structure.

25. The analyzer of clam 24, wherein said filter may be made with MEMS fabrication techniques.

26. The analyzer of claim 20, wherein said optical path varying mechanism may vary the optical path of said filter by heating said filter.

27. The analyzer of claim 26, wherein said optical path varying mechanism may heat said filter by providing current through a conductor in said filter.

28. The analyzer of claim 28, wherein said filter is a narrow band filter.

29. The analyzer of claim 28, further comprising a broad band filter situated between said radiation source and said narrow band filter.

30. The analyzer of claim 29, wherein said narrow band filter may be fabricated with MEMS technology.

31. Means for analyzing fluid comprising:
means for emitting radiation;
means for filtering proximate to said means for emitting radiation;
means for affecting a radiation path of said means for filtering;
means for containing some fluid proximate to said means for filtering; and
means for detecting radiation proximate to said means for containing some fluid.

32. The means of claim 31, wherein said means for affecting a radiation path of said means for narrow band filtering is a means for tilting said means for narrow band filtering.

33. The means of claim 31, wherein said means for affecting a radiation path of said means for narrow band filtering is a means for heating said means for narrow band filtering.

34. The means of claim 33, wherein said means for narrow band filtering is a monolithic device.

35. An analyzer comprising:
a light source;
a layer having two somewhat reflective surfaces so as to form an interference filter, proximate to said light source;
an element formed on said layer for heating said layer to vary the optical path length of said layer;
a cell for containing some fluid; and
a detector proximate to said cell.

36. The analyzer of claim 35, wherein:
the fluid in said cell has a spectrum of absorption lines;
said layer may form transmission peaks of infrared light from said light source;
a delta wavelength between the transmission peaks is similar to a delta wavelength between the absorption lines;
when the optical path length of said layer is varied, the transmission peaks and absorption lines move in and out of coincidence thereby affecting a magnitude of the light exiting said cell; and
said detector detects maximum and minimum magnitudes of the light exiting said cell.

37. The analyzer of claim 36, wherein the maximum and minimum magnitudes of the light from said detector may be indicative of at least one characteristic of the fluid in said cell.

38. The analyzer of claim 35, having a broadband filter situated between said light source and said layer.

39. An analyzer comprising:
a light source;
a layer having two somewhat reflective surfaces on it so as to form an interference filter;
a magnetic field mechanism proximate to said layer;
a conductor formed on said layer for conducting current within a magnetic field of said magnetic field mechanism to force said layer to tilt and vary an optical path length of said layer; and
a cell for containing some fluid proximate to said layer; and
a detector proximate to said cell.

40. An analyzer comprising:
a light source;
a layer having two somewhat reflective surfaces on it so as to form an interference filter;
a conductor formed on said layer for conducting current and heating said layer said layer to change thickness and vary an optical path length of said layer; and
a cell for containing some fluid proximate to said layer; and
a detector proximate to said cell.
